(19) United States
(12) Patent Application Publication
(10) Pub. No.: US 2005/0126810 A1
(43) Pub. Date: Jun. 16, 2005

(54) Chemical compounds

(76) Inventor: Christiaan Radelet, Scherpenheuvel (BE)

Correspondence Address: MYERS BIGEL SIBLEY & SAJOVEC, PO BOX 37428, RALEIGH, NC, 27627, US

(21) Appl. No.: 10/504,307

(22) PCT Filed: Feb. 5, 2003
(86) PCT No.: PCT/GB03/00510

(30) Foreign Application Priority Data
Feb. 16, 2002 (GB) 0203706.7

(51) Int. Cl. H02G 3/08

(52) U.S. Cl. 174/50

(57) ABSTRACT

A closure for enclosing at least one cable extends between two end faces. At least one cable entry port is located in a cable entry face which is spaced apart from both end faces by a distance at least equal to approximately 3 cm.

The present invention relates to a cable closure. More in particular the present invention relates to a closure for enclosing at least one cable, the closure extending between two end faces and comprising at least one cable entry port.

Cable closures are widely used to mechanically protect and/or environmentally seal cable portions, in particular cable splices. In addition, cable closures can be used to enclose devices connected to cables, such as electronic and/or optical devices. In general two main types of closures can be distinguished: in-line closures and butt closures. In the case of in-line closures, one or more cables enter the closure at one end and leave at the opposite end, the cables essentially extending in a straight line. In the case of butt closures, in contrast, cables enter and leave the closure at the same end, essentially following a U-shaped trajectory within the closure. In particular in the latter case, one of the end faces of the closure may be rounded or semi-spherical. Both types of closures can in principle be used for copper cables (including power cables), coaxial cables, fibre optic cables and/or combined (copper-fibre) cables. An example of a cable closure is described in International Patent Application WO 00/28634 (Tyco Electronics).

In use, cable closures are often located underground, either simply in a hole dug in the ground or in an underground cabinet, an example of which is disclosed in United States patent U.S. Pat. No. 5,888,078 (Lecreux). It will be clear that in either case the space required for accommodating the closure and the cables is an important cost consideration. Cables normally pass through the cable ports in an end face at a right angle to said face, thus allowing the cables to be led in any direction. The minimum bend radius of cables, however, requires a certain amount of extra space to be available beyond the end faces, thus effectively increasing the space required for accommodating the closure.

It is an object of the present invention to solve these and other problems of the Prior Art and to provide a cable closure which requires a minimum amount of space.

It is another object of the present invention to provide a cable closure which, while requiring a minimum amount of space, still allows cables entering and/or leaving the closure to extend substantially parallel to a longitudinal axis of the closure.

These and other objects are achieved by a closure as defined in the preamble which according to the present invention is characterised in that the at least one cable entry port is located in a cable entry face which is spaced apart from both end faces by a distance at least equal to approximately 3 cm.

By accommodating a cable entry port in a cable entry face which is set back from the nearest end face over a certain distance, said distance allowing the cable to be bent while maintaining its minimum bend radius, no extra space beyond the end faces of the closure is required for the cable(s) passing through the cable entry port. In a preferred embodiment, therefore, all cable ports are located in such a cable entry face, the end faces of the closure being devoid of cable entry ports. The cable entry face, which is distinct from the end faces, is set back at least approximately 3 cm, such a distance allowing cables having small diameters to be suitably bent. It will be understood, however, that the actual distance required depends on the cable diameter. In a preferred embodiment, therefore, said distance is at least equal to three times the diameter of the cable, preferably at least 15 times the diameter of the cable. In a particularly advantageous embodiment said distance is approximately equal to half the length of the closure.

It is noted that WO 00/28634 discloses the removal of a ridge protruding from the closure so as to open a cable port. Although it could be said that this removal creates an “offset” relative to the ridge of the adjacent port. The actual distance is very small, less than 3 cm, while said removal is carried out for an entirely different purpose.

Although a single cable entry face may suffice for many applications of the closure, it may be advantageous if at least two cable entry faces are provided, each having at least one cable entry port. In the case of in-line closures it is preferred to have two cable entry faces (or two groups of cable entry faces), each offset relative to a respective end face. In the case of butt closures two or more cable entry faces may be offset relative to the same end face. In either case, the said offset or distance may vary between cable entry faces and preferably is dependant on the particular type of cable.

In particular advantageous in-line closures two cable entry faces are provided on opposite sides of the closure, preferably facing in opposite directions. It is, however, possible to accommodate two cable entry faces providing access in opposite directions on the same side of the closure.

In a preferred embodiment, the at least one cable entry face is substantially perpendicular to a longitudinal direction of the closure. This implies that the cables passing through the cable entry ports extend substantially parallel to the longitudinal direction. It should be noted that the closures of the present invention need not be “longitudinal” in that they may have the form of a cube or even a sphere. However, in each case it will be possible to define a longitudinal direction.

It is also possible for the at least one cable entry face to be at an acute angle relative to a longitudinal direction of the closure, that is, to tilt “forward” so that cables emerge from the closure under an acute angle relative to said longitudinal direction. This has the advantageous effect of decreasing the length of the cable curve extending from the closure. Alternatively, the cable ports could be arranged at non-perpendicular angles relative to the cable entry faces.

The closure may consist of two parts which can be fastened together by screws, bolts, over-centre clamps or other means. Advantageously, sealing means such as rubber strips and/or gel strips are provided to seal the two parts. The parts may be so-called half-shells or may comprise a container and a lid.

The present invention further provides a kit-of-parts for forming a closure as defied above, and an underground cable cabinet provided with such a closure.

The invention will now further be explained below with reference to the accompanying drawings, in which:

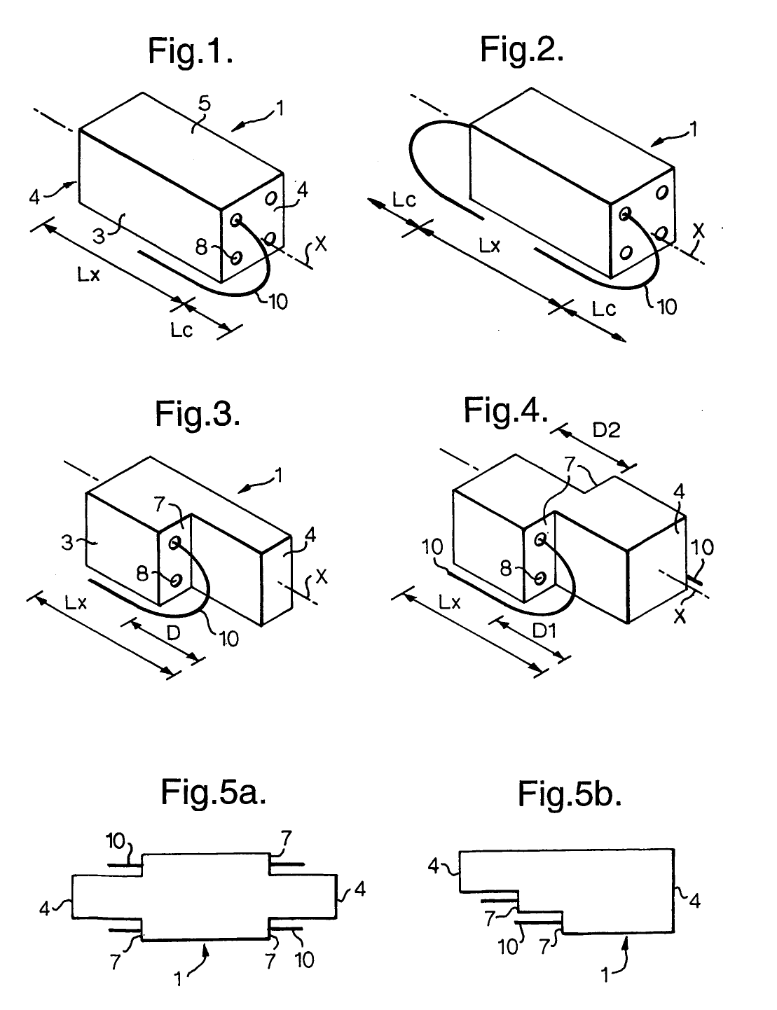

FIG. 1 schematically shows, in perspective, a butt closure according to the Prior Art;

FIG. 2 schematically shows, in perspective, an in-line closure according to the Prior Art;

FIG. 3 schematically shows, in perspective, a butt closure according to the present invention;

FIG. 4 schematically shows, in perspective, an in-line closure according to the present invention;

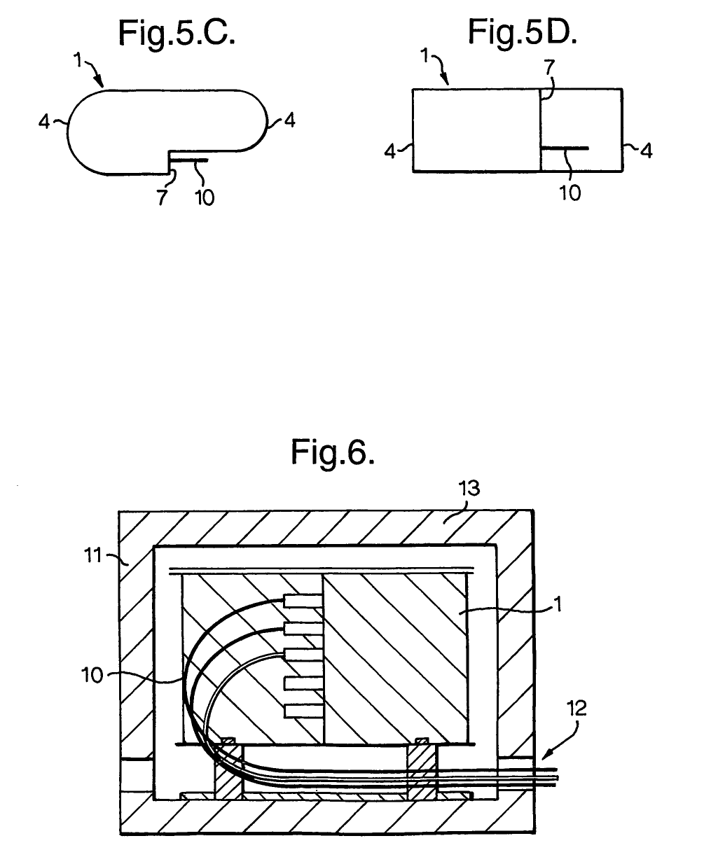

FIGS. 5a-d schematically show, in top view, alternative embodiments of the closure according to the present invention; and

FIG. 6 schematically shows, in side-view, an underground cabinet according to the present invention.

The Prior Art cable closure 1 shown in FIG. 1 has side faces 3, end faces 4 and a top face 5. The generally rectangular closure 1 has a longitudinal axis X defining a longitudinal direction.

The end face 4 shown in FIG. 1 is provided with four cable entry ports 8. A cable 10 is shown to pass through one of the cable entry ports 8. The cable is bent back towards the closure. To prevent any damage to the cable, a minimum bend radius must be maintained which depends on, inter alia, the cable diameter and the type of cable. As shown in FIG. 1, the total length of the arrangement is Lx+Lc, where Lx is the length of the closure and Lc is the size of the cable curve. It will be clear that Lc is at least equal to the minimum bend radius of the cable which may range from 3 cm to 30 cm or more.

In the case of an in-line closure, as shown in FIG. 2, cables enter and exit the closure 1 at both ends. The minimum space required by the arrangement shown is Lx+2.Lc, that is, the length of the closure plus twice the minimum bend radius. This increased space requirement due to the cable curves is clearly undesirable as it increases the cost of any underground cabinet or manhole in which the closure is to be accommodated.

As shown in FIGS. 3 and 4, the present invention offers a simple yet very effective solution to this problem. In the closure of FIG. 3, the cable entry ports 8 are located in an additional cable entry face 7 instead of the end face 4. The cable entry face 7 is located at a distance D from the end face 4, measured along the longitudinal axis X. As a consequence, there is no need for extra space (Lc) to accommodate the bent cable.

In accordance with the present invention, the distance or spacing D is at least equal to the minimum bend radius of the cable 10. In practise, the distance D will be at least approximately 2.5 cm, preferably at least approximately 3 cm, more preferably at least 10 cm.

As shown in FIG. 3, the end face 4 and the cable entry face 7 are substantially parallel and lie in planes which are both perpendicular to the axis X. This is not essential and either the end face 4 or the cable entry face 7, or both, could be tilted in either direction relative to the positions shown. Instead of 2 cable entry ports the face 7 could be provided with only a single cable entry port 8, or a plurality of such ports.

The closure of FIG. 4 is particularly suitable for in-line use, having two cable entry faces 7 located on opposite sides of the closure 1 and facing in opposite directions. The cable entry faces 7 are each spaced apart from a corresponding end face 4 by a distance D1 and D2 respectively. The distances D1 and D2 may be different so as to suit different cables 10.

Alternative embodiments of the closure 1 of the present invention are schematically shown in FIGS. 5a-d. In FIG. 5a, a closure having four cable entry faces 7 is shown. In FIG. 5b, two cable entry faces 7 are set back over different distances. In FIG. 5c, the closure is approximately oval while in FIG. 5d the cable entry face 7 is located at the top of the closure instead of at the side.

As shown in FIG. 6, a closure 1 of the present invention may advantageously be used in an underground cabinet 11 which may be made of concrete or steel. Openings 12 provide cable access to the interior of the cabinet. A removable lid 13 provides access to the closure.

It will be understood by those skilled in the art that various modifications and additions may be made without departing from the scope of the invention as defined in the appending claims.

1. A closure for enclosing at least one cable, the closure extending between two end faces, the closure further comprising at least one cable entry port located in a cable entry face which is spaced apart from both end faces by a distance (D) at least equal to approximately 3 cm.

2. A closure according to claim 1, wherein said distance (D) is at least equal to three times a diameter of the cable.

3. A closure according to claim 1, wherein said distance (D) is approximately equal to half a length (Lx) of the closure.

4. A closure according to claim 1 wherein the at least one cable entry face at least two cable entry faces, each of the cable entry faces having at least one cable entry port.

5. A closure according to claim 4, wherein the at least two cable entry faces are provided on opposite sides of the closure facing in opposite directions.

6. A closure according to claim 4, wherein the at least two cable entry faces are provided on a same side of the closure, facing in opposite directions.

7. A closure according to claim 1, wherein the at least one cable entry face is substantially perpendicular to a longitudinal direction of the closure.

8. A closure according to claim 1, wherein the at least one cable entry face is at an acute angle relative to a longitudinal direction of the closure.

9. A closure according to claim 1, the closure comprising two parts and fastening means for fastening the parts together and sealing means for sealing the parts.

10. A kit-of parts for forming a closure according to claim 1.

11. An underground cable cabinet, provided with a closure according to claim 1.

12. A closure for enclosing at least one cable, the closure comprising:
two end faces on opposite ends of the closure;
a first cable entry face spaced apart from at least one of the end faces and facing a first direction;
a second cable entry face spaced apart from at least one of the end faces and facing a second direction that is opposite the first direction; and
at least one cable entry port on each of the first and second cable entry faces.

13. A closure for enclosing at least one cable, the closure comprising:
two end faces on opposite ends of the closure;
at least one cable entry face having at least one cable entry port thereon, the at least one cable entry face being spaced apart from a corresponding one of the end faces by a distance configured to accommodate a bent cable passing through the at least one cable entry port so that the bent cable does not extend beyond the corresponding one of the end faces.

14. The closure of claim 13, wherein the at least one cable entry face comprises at least two cable entry faces that are spaced apart from the end faces on opposite sides of the closure and face in opposite directions.

15. The closure of claim 1, wherein said distance D is at least equal to fifteen times a diameter of the cable.
